(19) United States
(12) Patent Application Publication
(10) Pub. No.: US 2009/0111486 A1
(43) Pub. Date: Apr. 30, 2009

(54) DEVICE AND METHOD FOR GENERATING A MESSAGE

(75) Inventor: David Per BURSTROM, Lund (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/925,265

(22) Filed: Oct. 26, 2007

(51) Int. Cl. H04Q 7/20

(52) U.S. Cl. 455/456.3

(57) ABSTRACT

One or more embodiments may concern a portable communication device comprising a detection unit and a control unit, said portable communication device being adapted to use an information template for generating a message. The detection unit is configured to detect a physical entity. The control unit is configured to insert information corresponding to the detected physical entity, detected by the detection unit into a pre-specified position in the message template. One or more embodiments may also concerns a method for generating a message in a portable communication device by using an adaptive information template.

### TECHNICAL FIELD

One or more embodiments disclosed herein may relate to the field of portable communication devices. More particularly, one or more embodiments may relate to a portable communication device and a method for generating a message when using a template within the portable communication device.

### BACKGROUND OF THE INVENTION

Portable communication devices, such as cordless and cellular telephones, pagers, wireless modems, wireless email devices, personal digital assistants (PDAs) with communication functions, MP3 players and other portable communications devices are becoming increasingly commonplace. Some of these portable communication devices are equipped with a Global Positioning System (GPS) and may be configured to communicate with other devices over the wireless communications network. Users of these portable communication devices may take these devices with them anywhere they go, which may allow these users to, for example, place phone calls, check an appointment on a calendar, check email, take pictures and/or access the Internet and the information available thereon.

Portable communications devices may use displays, such as liquid crystal displays (LCDs), as input/output devices for various functions and applications. Such function may include sending an SMS or MMS message or an email to a remote recipient. It may also be used for composing any kind of text, such as a memory note. As a portable communication device may be portable, a user may want to write a text or make a document when he/she is traveling, e.g., mobile. There may not enough time to write and prepare a proper text, or the user may have to partially concentrate on something else while writing the text. It may also be difficult for some people, e.g., dyslectics or people with writer's block to start from an empty display and try to formulate a text.

One solution that has been proposed in order to meet this problem and to facilitate communication is to create templates for SMS, MMS or e-mail. However, these templates may include only static text. When the template is used as a starting point for the creation of a text, the user may need to manually type in the recipients name and other information. This work may be tedious, time consuming and may lead to spelling mistakes, etc.

It may also be a problem for some people to remember what they have been doing during a day, such as which places and/or people they have been meeting and at what time they met a certain person, etc. There may also be a problem, for example, for a consultant to report in detail to a curious client how much time he has spent on a certain commission, after some time has passed.

It may be a problem to mass communicate a personalized message to a group of recipients, e.g. when inviting a large group of people to a party, etc.

It may be a problem to communicate a danger alert to a large group of people in a fast and accurate way. For example, even if seismologic activity is detected within a certain geographical area and, e.g., a tsunami wave may be predicted, it may be a problem to provide the people in the danger zone with a warning and instructions how to avoid or minimize the danger.

In addition, as competition increases among manufacturers of portable communication devices, there may be a marketing need for new functions and features.

### SUMMARY OF THE INVENTION

One or more embodiments disclosed herein may obviate or reduce at least some of the above mentioned problems and provides an improved portable communication device.

A first aspect of of one or more embodiments may be directed towards a portable communication device comprising a detection unit and a control unit. The portable communication device may be adapted to use a message template for generating a message for a recipient. The detection unit may be configured to detect a physical entity. The control unit may be configured to enter, e.g., insert, information corresponding to the detected physical entity, detected by the detection unit, into a pre specified position in the message template.

A second aspect of one or more embodiments may include the features of the first aspect, wherein the detection unit (230, 250) may be a position detecting unit and the physical entity may be position data corresponding to the present geographical position of the portable communication device.

A third aspect of one or more embodiments may include the features of the second aspect, wherein the control unit is configured to map position data detected by the detection unit onto a natural language denomination, which is the information, before being entered into the pre specified position in the message template.

A fourth aspect of one or more embodiments may include the features of the third aspect, wherein the detected position data corresponds to a group of natural language denominations of different precision, where each natural language denomination corresponds to a geographical area of different size.

A fifth aspect of of one or more embodiments may include the features of the fourth aspect, wherein the control unit is configured to select the natural language denomination corresponding to a detected position data depending on the distance between a home location of the recipient and the detected geographical position.

A sixth aspect of of one or more embodiments may include the features of the fifth aspect, wherein the control unit is configured to order the communication unit to send a message.

A seventh aspect of of one or more embodiments may include the features of the first aspect, wherein the detection unit may include one unit out of the group: a temperature sensor, a Bluetooth unit, an accelerometer, a light sensor, a sensor measuring the sound level of the environment, a barometer, a sensor device for determine the air pressure, a humidity sensor, a breath analyzer, a clock, a calendar, a pulse meter, a blood pressure sensor.

An eighth aspect of of one or more embodiments may include the features of the first aspect, wherein the portable communication device comprising a group of detection units and a group of pre specified positions in a template.

A ninth aspect of of one or more embodiments may include directed towards a method for generating a message in a portable communication device by using a message template comprising at least one pre specified position. The method may include detecting a physical entity. Also, the method may include entering relevant information corresponding to the detected physical entity into the pre specified position in the template.

A tenth aspect of of one or more embodiments may include the features of the ninth aspect wherein the detected physical entity may include position data corresponding to the present geographical position of the portable communication device.

A eleventh aspect of of one or more embodiments may include the features of the tenth aspect further comprising mapping the data corresponding to a geographical position onto a natural language denomination, which is the information.

A twelfth aspect of of one or more embodiments may include the features of the ninth aspect further comprising detecting that the portable communication device is set into a template mode. Further, it may include activating a detection unit, and preparing the detected physical entity for presentation.

A thirteenth aspect of of one or more embodiments may include the features of the twelfth aspect wherein the selection of the natural language denomination corresponding to a detected position data is depending on the home location of the recipient.

A fourteenth aspect of of one or more embodiments may include the features of the thirteenth aspect, wherein selecting natural language denomination corresponding to detected position data may further include selecting a natural language denomination corresponding to a geographical area wherein the geographical position of the portable communication device is comprised. The natural language denomination is also corresponding to a geographical area which is separate from the determined home location of the recipient.

A fifteenth aspect of of one or more embodiments may include the features of the fourteenth aspect, wherein sending a generated message automatically is comprised.

A sixteenth aspect of of one or more embodiments may include the features of the ninth aspect, wherein the captured relevant data may include data out of the group: temperature, name of other Bluetooth units within range, accelerometer data, light intensity data, sound level data, barometer data, air pressure, height over the sea level, air humidity data, the users alcohol content when exhaling, time, calendar data, pulse, blood pressure.

A seventeenth aspect of of one or more embodiments may include the features of the ninth aspect, wherein the detection unit is continuously activated and the portable communication device is set into a template mode when the detected data reaches or exceeds a certain predetermined threshold value.

An eighteenth aspect of one or more embodiments may include the features of the ninth aspect, wherein a group of detection units are activated and a group of relevant data is captured and entered into a group of pre specified areas in the template.

A nineteenth aspect of one or more embodiments may include the features of the ninth aspect, wherein a group of messages are distributed to a group of recipients.

A twentieth aspect of one or more embodiments may include is directed towards a computer program product comprising computer-readable program code embodied on a computer-readable medium, the computer readable program code being configured to carry out the method according to the ninth aspect.

Since the place holders in the message templates may be included within the portable communication device according to one or more embodiments may be adapted to receive relevant information, an adaptive message template is created. The adaptive message template could be used to generate messages with a minimum of time and effort required from the user. Thus, it is possible to send a message or update a log book or a web page automatically. A personalised message may be sent to a group of recipients without requirement of additive effort or loss of time.

An advantage of the present device, method, computer program is that a personalized message may be generated and delivered to a recipient almost effortlessly.

An advantage of the present device, method, computer program is that a log book could be generated automatically and/or a web page could be updated automatically.

### BRIEF DESCRIPTION OF THE DRAWINGS

One or more embodiments will now be described more in detail in relation to the enclosed drawings, in which:

FIG. 1 is a schematic illustration over an embodiment of an information template using a portable communication device in a wireless communication network;

FIG. 2 is a flow chart illustrating a method in a portable communication device in a wireless communication network; and

FIG. 3 schematically depicts an embodiment of a portable communication device comprising inter alia a detection unit.

### DETAILED DESCRIPTION OF PREFERRED EMBODIMENTS

One or more embodiments include a portable communication device, a method, and a computer program that may be put into practice in the embodiments described below. This invention may, however, be embodied in many different forms and should not be construed as limited to the embodiments set forth herein; rather, these embodiments are provided so that this disclosure will be thorough and complete, and will fully convey the scope of the invention to those skilled in the art. It should be understood that there is no intent to limit the present portable communication device, method, or computer program to any of the particular forms disclosed, but on the contrary, the present portable communication device, method, and computer program is to cover all modifications, equivalents, and alternatives falling within the spirit and scope of the invention as defined by the claims.

One or more embodiment disclosed herein may facilitate communication when writing on the displays of portable communication devices.

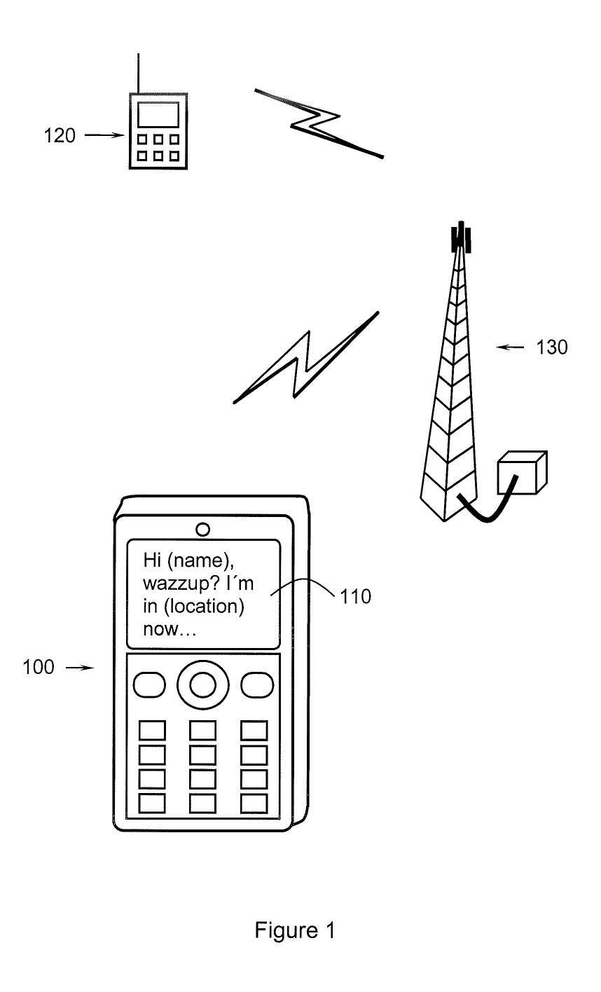

Referring to FIG. 1, a schematic block diagram is provided illustrating a first portable communication device 100, a second portable communication device 120 and a base station transceiver 130 of a wireless communication network in accordance with some embodiments.

The portable communication device 100 and/or 120 as herein described may, in one embodiment, include a mobile station such as a mobile cellular radiotelephone. However, as used herein, a “portable communication device” may include both devices having only a wireless signal receiver without transmit abilities and devices having both receive and transmit hardware capable of two-way communication over a two-way communication link. The portable communication device 100 and/or 120 may in some embodiments be semi-portable (e.g., somewhat not so very portable) and may include, e.g., a stationary computer.

The portable communication device 100 and/or 120 may, according to some embodiments, be a Personal Digital Assistant (PDA), a laptop, a digital still camera, a digital video camera or any other kind of portable electronic device, such as a notebook computer, walkie-talkie, hunting radio, baby monitor, etc. The portable communication device 100 and/or 120 may, in one embodiment, be a foldable portable communication device such as a clam shell or foldable knife-type cellular phone, e.g., Sony Ericsson W300i. As used herein, a “portable communication device” may be portable, transportable, movable, installed in a vehicle, aeronautical, maritime, or land-based, or situated and/or configured to operate locally and/or in a distributed fashion at any other location(s) on earth and/or in space.

As discussed herein with respect to the figures, one or more embodiments may provide a portable communication device, method, and computer program product for providing an adaptive information template within the portable communication device.

Further, FIG. 1 illustrates a first portable communication device 100, a second portable communication device 120, and a base station transceiver 130. In some embodiments, the base station transceiver 130 may be a radio transceiver that defines a cell in a cellular network and communicates with the portable communication device 100 and other portable communication devices 120 in the cell using a radio-link protocol. Although only one base station transceiver is shown in FIG. 1, many base station transceivers 130 may be connected through, for example, a mobile switching centre and other devices, to define a wireless communications network.

It will be understood that as wireless technologies evolve, so do “wireless communication networks.” As used herein, a “wireless communication network” may refer to various radio access technologies in the traditional sense, a wireless local area network (LAN) or a wireless personal area network without departing from the teachings of the present invention. These networks may include, for example, radio access technologies, such as Code Division Multiple Access (CDMA), Wideband Code Division Multiple Access (WCDMA), Enhanced Data rates for GSM Evolution (EDGE), General Packet Radio Service (GPRS), Global System for Mobile Telecommunications (GSM), High-Speed Downlink Packet Access (HSDPA), High-Speed Uplink Packet Access (HSUPA), High Speed Packet Data Access (HSPA), Universal Mobile Telecommunications System (UMTS) and/or Wireless Local Area Networks (WLAN), such as Wireless Fidelity (WiFi) and Worldwide Interoperability for Microwave Access (WiMAX) or according to any other 5 wireless communication standard.

One or more embodiments may not be limited to a wireless communication network, but may be performed in any kind of network, e.g., in a wired network, or even without a network connection.

The portable communication device 100 may include, e.g., a keypad, a camera module, a speaker, a microphone, a transceiver, and a memory, any of which may communicate with a controller, e.g., a processor and a display. Furthermore, the portable communication device 100 also may include environmental detection units such as a GPS unit, or similar unit for geographical orientation. Other examples of such environmental detection units that may be included within the portable communication device 100 are, e.g., a temperature sensor, a Bluetooth unit, an accelerometer, a light sensor, a sensor measuring the sound level of the environment, a barometer, a sensor device for telling the air pressure, thus indicating the height over the sea level, a humidity sensor, a breath analyzer such as a breath analyzer for sensing alcohol, a clock, a calendar, a pulse meter, a blood pressure sensor, gas indicator, Geiger counter, etc. Detection units may detect physical attributes or characteristics of the surrounding environment.

The environmental detection units may be physically included within the portable communication device 100 or external to the portable communication device 100 but may communicate with the portable communication device 100, for example, by using an identifiable short range radio device, e.g., a Bluetooth connection, a wired connection, or other suitable means for communication exchange.

The portable communication device 100 is provided with an adaptive template 110 for sending a text, e.g., a Short Message Service (SMS), Multimedia Messaging Service (MMS), electronic mail (e-mail), letter, note, epistle, post card, log book, text on a personal web page, blog, diary or similar. The adaptive template 110 may be selected from a list by the user and may be displayed on the display of the portable communication device 100. According to some embodiments, the most appropriate adaptive template is selected automatically by a program, depending on detected sensor information. The adaptive template 110, according to one or more embodiments, may include at least one place holder 140, which is replaced by detected relevant information, such as the recipients given name, geographical or environmental information.

In the adaptive template 110 illustrated in FIG. 1, the place holders 140 are “(name)”, which may be replaced with the recipient's given name, and “(location)” which may use GPS information to find out the location, e.g., city the user currently is in. A resulting text which may be generated by the adaptive template 110 depicted in FIG. 1 may be: “Hi Dave, wazzup? I'm in London now”.

Other examples of relevant information, e.g., environmental information that may be automatically inserted in a place holder 140 in an adaptive template 110 for generating an information may be temperature, time, a weather indication, sound level information, light intensity, air pressure information, etc., to just give a few examples.

The relevant information that may be detected and placed into the place holders 140 in the adaptive template 110, may have to be analyzed and/or categorized and/or interpreted and/or converted before it may be used in the text. For example, the GPS information that is inserted into the place holder “(location)” in the example above may not include the latitude/longitude coordinates, but rather an interpretation of what city is situated on those coordinates. This interpretation may enhance readability. However, there may be situations when it may be preferred to send the detected relevant information without analyse and/or categorization and/or interpretation and/or conversion. An example of such situation may be when the user has lost his/her way in a desolate environment.

Another example of an adaptive template 110 with place holders 140 may be: Hi (name)! Now I have arrived in (location), at the (height). It is (baro) here, with (degree). I'm having a (noise level) time here. Actually I'm (alco level). See you later, (user name).

A resulting generated information may be: “Hi Dave! Now I have arrived in Kos, at the beach. It is hot and sunny here, with +35 degrees. I'm having a great time here. Actually I'm completely drunk. See you later, Daniels”. In the resulting information, the following relevant information has been detected and placed in the corresponding place holders 140:

| placeholder | explanation | resulting information |
|---|---|---|
| (name) | recipients given name | Dave |
| (location) | geographical position | Kos |
| (height) | height over sea level | beach |
| (baro) | barometer information | hot and sunny |
| (degree) | temperature | +35 degrees |
| (noise level) | registrated sound level | great |
| (alco level) | breath analyzer information | completely drunk |
| (user name) | users given name | Daniela |

The same adaptive template 110 may be used to generate completely different information under other environmental circumstances, e.g.: “Hi Dave! Now I have arrived in Chamonix, high in the mountains. It is cold and bad weather, with −15 degrees. I'm having a peaceful and relaxed time here. Actually I'm completely bored. See you later, Daniela”.

In the resulting information, the following relevant information has been detected and placed in the corresponding place holders 140:

| placeholder | explanation | resulting information |
|---|---|---|
| (name) | recipients given name | Dave |
| (location) | geographical position | Chamonix |
| (height) | height over sea level | high in the mountains |
| (baro) | barometer information | cold and bad weather |
| (degree) | temperature | −15 degrees |
| (noise level) | registrated sound level | peaceful and relaxed |
| (alco level) | breath analyzer information | bored |
| (user name) | users given name | Daniela |

As demonstrated, one adaptive template 110 may generate a group of very different texts, depending on the detected relevant information.

In both generated messages above, a photo, e.g. the most recently taken photo, taken with a camera included within the portable communication device 100 may be attached to the message. According to some embodiments, a predetermined picture associated with the detected geographical position may be selected and attached to the message.

When the template 110 is stored in the file system of the portable communication device 100 the place holders 140, according to some embodiments, may be saved in a language independent format. When the adaptive template 110 is viewed or edited, the place holders 140 may be displayed according to the user selected language on the portable communication device 100.

Further, in the template editor, there may be a list of different place holders 140 (in one embodiment all different place holders 140) to select from when a user wants to create an adaptive template 110.

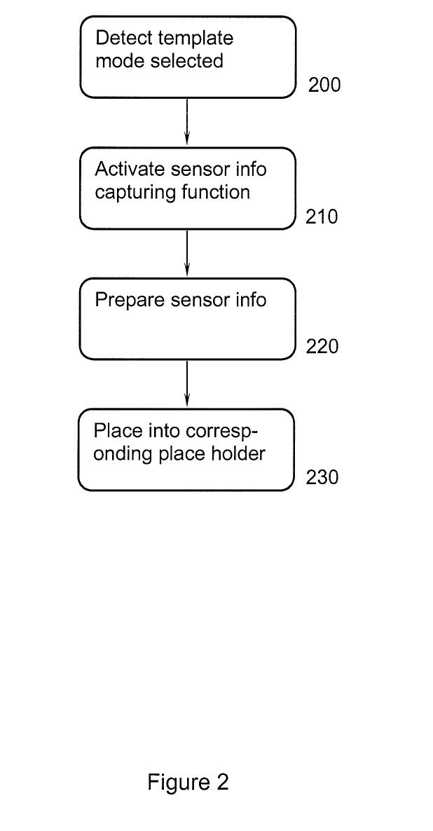

FIG. 2 is a flow chart illustrating a method in the portable communication device 100 for providing an adaptive information template 110 with place holders 140. The method concerns the inclusion of relevant information into dedicated place holders 140 in the adaptive information template 110, when using the portable communication device 100. The method may include:

### Block 200

It may be detected that the portable communication device 100 is set into a template mode. The selection of a template mode may be made by the user manually, when writing a text on the portable communication device 100. However, the portable communication device 100 may, according to some embodiments, be set into template mode remotely, e.g., when an SMS is received. This may be an advantage, in particular when the portable communication device 100 is used for surveillance.

According to some embodiments, the portable communication device 100 may be set into a template mode when a dedicated button is pressed by the user. The dedicated button may in some embodiments be a soft key or include an accord of key pressures.

According to some embodiments, the portable communication device 100 is constantly detecting environmental data, e.g., seismographic data and the portable communication device 100 is set into a template mode when a certain predetermined threshold value is reached.

### Block 210

When it has been detected that the portable communication device 100 is set into a template mode, the detection units included within the portable communication device 100 may be activated, according to some embodiments. Thus, relevant sensor data, such as environmental data may be captured, depending on the place holders 140 included within the selected template 110.

The detected relevant sensor data may be, e.g., geographical data detected by a GPS or similar device. It may also be temperature, atmospheric pressure, time, light intensity, date, calendrical information, air humidity, noise level, light level, seismic activity, air pollution, radiation, etc.

### Block 220

When relevant sensor data has been detected by the detection units included within the portable communication device 100, the relevant information may be prepared for presentation. The preparation of the relevant information may further include any or even all of analyzing the received sensor data, categorizing the received relevant sensor data into a certain category, interpreting the received sensor data and/or converting the received sensor data into relevant information.

According to one or more embodiments, the detected position data may correspond to a group of natural language denominations of different precision, such that each natural language denomination may correspond to a geographical area of different size. A natural language denomination is a name corresponding to a geographical area, e.g., a group of geographical position data, e.g., Stockholm.

Preparation of relevant sensor data may be different for different types of sensor data. For example, the preparation of geographical data received from a GPS or corresponding device may include matching the received geographical coordinates against a list of geographical localities and selecting the locality that provides the best match. That is, select the natural language denomination that best correspond to the detected position data. Thus, preparing the relevant data for presentation may further include converting the data corresponding to a geographical position into a natural language denomination. Consequently, converting the data corresponding to a geographical position into a natural language denomination may include parsing the position data against predetermined position data corresponding to a natural language denomination of the geographical position.

As an example, if the GPS coordinates N59′19.80012 and E018′4.2 are received, these may be parsed against a list of localities with their coordinates and the extracted relevant information from such a parsing may be “Stockholm”, “city centre” or “central station” depending on the dissolution and/or user selection and/or users registered subscription address. Thus, the precision of the natural language denomination corresponding to a detected position data may be dependent on the home location of the recipient.

According to some embodiments, the precision of the natural language denomination corresponding to a detected position data may depend on the distance to the home location of the recipient. According to these embodiments, the position of the recipient of a message may be received from the phone book included within the portable communication device 100. Alternatively, the position of the recipient may be calculated from the address information concerning the recipient, which address information may be included within the phone book. If the recipients position is situated within the geographical area corresponding to the geographical position of the portable communication device 100, a second more precise natural language denomination may be selected.

For example, if a user situated in Stockholm sends a message to a recipient based in Stockholm, the natural language denomination “Stockholm” may not be selected. Instead, a more precise natural language denomination is selected, such as “city centre” or 25 “Sveavagen”.

### Block 230

When the relevant information has been prepared it may be placed within the corresponding place holders 140 in the selected adaptive template 110. Thus, information may be generated, which may be sent to the intended recipient or group of recipients. The information may, according to some embodiments, be sent to a non-human recipient, e.g., to a blog site, virtual log book or similar.

According to some embodiments, the generated information may not be sent at all, e.g., when a network connection is unavailable, but instead stored in a memory unit included within the portable communication device 100.

According to some embodiments, the method for generating a message to a recipient in a portable communication device 100 may use a message template 110 including at least one pre specified position. The method may include detecting 200 that the portable communication device 100 is set into a template mode. The method further may include activating 210 a detection unit 230, 250 and capturing relevant data. Further, the method may include preparing 220 the relevant data for presentation, and generating 230 information by entering the relevant information corresponding to the detected relevant data into the pre specified position in the template 110.

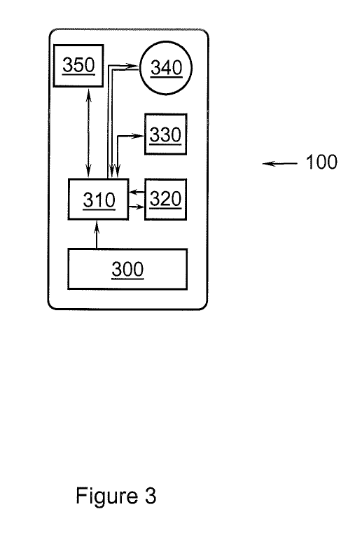

FIG. 3 schematically depicts an embodiment of a portable communication device 100 including, e.g., a keypad, a camera module 340, a display, a speaker, a microphone, a transceiver 300, and a memory 320, any of which may communicate with a control unit 310, e.g., a processor. Furthermore, the portable communication device 100 also may include environmental detection units 330, 350 such as a GPS unit, or similar unit for geographical orientation. Other examples of such environmental detection units 330, 350 that may be included within the portable communication device 100 are, e.g., a temperature sensor, an accelerometer, a light sensor, a sensor measuring the sound level of the environment, a barometer, a sensor device for telling the air pressure, thus indicating the height over the sea level, a humidity sensor, a breath analyzer such as a breath analyzer for sensing alcohol, a clock, a calendar, a gas indicator, a Geiger counter, etc.

The control unit 310 included within the portable communication device 100 may be a Central Processing Unit (CPU), a microprocessor, a Peripheral Interface Controller (PIC) microcontroller or any other appropriate device adapted to interpret computer program instructions and processes data.

The memory unit 320 may be a primary storage memory unit such as a processor register, a cache memory, a Random Access Memory (RAM) or similar. The memory unit 320 may, however, in some embodiments be a secondary memory unit such as a Read Only Memory (ROM), Electrically Erasable Programmable Read-Only Memory (EEPROM), programmable read-only memory (PROM) or erasable programmable read-only memory (EPROM) or a hard disk drive. The memory unit 320 may, however, in some embodiments be an off-line storage memory unit, a flash memory, a USB memory or a memory card. The memory unit 320 may in some embodiments be a Network-attached storage (NAS) or in fact any other appropriate medium such as a disk or a tape that can hold machine readable data.

The control unit 310 may according to some embodiments be adapted to determine when to activate and when to deactivate the template mode of the portable communication device 100. This may be done, e.g., when the portable communication device 100 is used for surveillance of e.g., a house, a hotel room, a vehicle, etc. The user may, e.g., send an SMS to the portable communication device 100, with a certain activation code, which triggers the control unit 310 to activate the template mode.

According to some embodiments, the portable communication device 100 is triggered to enter template mode regularly, e.g., triggered by a timer included within the portable communication device 100.

Furthermore, the portable communication device 100 may also include environmental detection units 330, 350 such as a GPS unit, or similar unit for geographical orientation, which also communicate with the control unit 310. According to some embodiments, cell ID may be used instead of the GPS unit or as a complement to the GPS unit. The control unit 310 may be any commercially available or custom microprocessor, e.g., a Central Processing Unit (CPU), a Peripheral Interface Controller (PIC) microcontroller or any other appropriate device adapted to interpret computer program instructions and process data.

Although some embodiments are discussed herein with respect to GPS, one or more embodiments may not be limited to such configuration. Furthermore, as used herein, “localization” of a geographical position refers to receiving coordinates from, for example, the GPS, and check, e.g., against a list which domain the coordinates belongs to. The domain may be a city, a part of a city, a street, a bar, a suburban, a country, a continent, etc.

Although the environmental detection unit 330, 350, e.g., a GPS unit, is illustrated as included within the portable communication device 100 in FIG. 3, embodiments may not be limited to this configuration. For example, the environmental detection unit 330, 350 may be external to the portable communication device 100. The environmental detection unit 330, 350 may communicate with the portable communication device 100 via, for example, Bluetooth, a wired connection or any other suitable means for communication and/or exchange of data.

As further illustrated, the portable communication device 100 may include a transceiver 300 which may include a transmitter circuit and a receiver circuit, which respectively transmits outgoing radio frequency signals to the base station transceiver 130 and receives incoming radio frequency signals, such as voice call and data signals, from the base station transceiver 130 via an antenna. The antenna may be an embedded antenna, a retractable antenna or any type of antenna. The radio frequency signals transmitted between the portable communication device 100 and the base station transceiver 130 may include both traffic and control signals, e.g., paging signals/messages for incoming calls, which may be used to establish and maintain a voice call communication with another party or to transmit and/or receive data, such as e-mail or Multimedia Message Service (MMS) messages, with a remote device 120. The processor 310 may support various functions of the portable communication device 100, including functions related to the detection units 330, 350 included within the portable communication device 100.

The method for creating an adaptive information template in a portable communication device 100 according to the present method may be implemented through one or more processors 310, such as the processor unit 310 in the portable communication device 100 depicted in FIG. 3, together with computer program code for performing the functions of 30 the method. The program code mentioned above may also be provided as a computer program product, for instance, in the form of a data carrier carrying computer program code for performing the method according to one or more embodiments when being loaded into a processor unit 310. The data carrier may be a CD ROM disc, a memory stick, or any other appropriate medium such as a disk or tape that can hold machine readable data. The computer program code can furthermore be provided as pure program code on a server and downloaded to the portable communication device 100 remotely.

Thus, a computer program comprising instruction sets for performing the method according to FIG. 2 may be used for implementing the previously described method.

One or more embodiments may be embodied as an adaptive template 110, a portable communication device 100, a method or a computer program product. Accordingly, one or more embodiments may take the form of an entirely hardware embodiment, a software embodiment or an embodiment combining software and hardware aspects all generally referred to herein as a “circuit” or “module.” Furthermore, one or more embodiments may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of one or more embodiments may be written in any arbitrary object oriented programming language such as Java@, Smalltalk or C++. However, the computer program code for carrying out the present method may also be written in any conventional procedural programming languages, such as the “C” programming language and/or a lower level assembler language. The program code may execute entirely on the user's portable communication device 100, partly on the user's portable communication device 100, as a stand-alone software package, partly on the user's portable communication device 100 and partly on a remote computing device or entirely on the remote computing device. In the latter scenario, the remote computing device may be connected to the user's portable communication device 100 through a local area network (LAN) or a wide area network (WAN), or the connection may be made to an external computer, for example, through the Internet using an Internet Service Provider.

Furthermore, the present method was described in part above with reference to flowchart illustrations and/or block diagrams of portable communication device 100, templates, methods, and computer program products according to one or more embodiments. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor 310 of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The method of generating an adaptive text template in a portable communication device may be used when mass communicating a personalized message to a group of recipients. A standardized message, e.g., an invitation to a wedding may be sent to several recipients simultaneously, or almost simultaneously, with an alteration of the name of the recipient in each message. Thus, the process of sending email may be speeded up significantly.

One or more embodiments may mass communicate a personalized message to a group of recipients, e.g., when inviting a large group of people to a party, etc. One or more embodiments may also be used in order to inform the travelers of, e.g., a certain flight that the flight has been delayed. In the personalized message, relevant information such as recipients name, flight number, gate, new departure time, etc., may be inserted at accurate places in the message.

The method of generating an adaptive text template in a portable communication device may also be used by the relatives to, e.g., alpinists, adventurers and the like, who may be worried about their adventurous relative. According to some embodiments, a message, e.g., an SMS with a certain activation code is sent to the portable communication device 100, which may be triggered to set the portable communication device 100 into template mode and respond with a standard template 110 comprising at least some detected sensor data and/or relevant information.

According to some embodiments, the template mode may be activated automatically, e.g., every hour, or once every 10 km that the location coordinates has changed. Thus, an automatic log book may be generated, which may be beneficial, e.g., for yachtsmen, alpinists, adventurers, multi sport practitioners and similar. This may be a help for creating a log book automatically, without loosing valuable time.

With these lastly described embodiments, the template mode may be activated automatically, without requiring further effort from the user.

According to some embodiments, an accelerator unit is included within the portable communication device 100. The accelerator unit may determine if the user of the portable communication device 100 is, e.g., walking, running or resting, which information may be incorporated in an information template. Further, this information may be compared with geographical data detected by a GPS and time data. Thus, the user's speed and energy consumption in calories may be estimated. This information may be compared against the user's food supply to calculate how long time, e.g., how many days the food will last, for example, when doing an expedition into a sparsely populated area.

According to one or more embodiments, identifiable short range radio devices, such as Bluetooth identification, may be used to control which users may be close to the user and that information may be included within a template. For example, the template: “I am in (location) (company)” may generate the text: “I am in the city centre with Daniela”.

In some embodiments, a blog button is included within the portable communication device 100. The blog button may be a physical button, a soft key, or it may include an accord of button strokes. When the user press the blog button, the portable communication device 100 may be set into template mode and information is generated according to a template, which information may be sent to a blog site, a virtual log book or similar. According to some embodiments, the lastly took photographical picture is enclosed with the information, or a user selected image is attached to the information.

According to one or more embodiments, adaptive information templates 110 may be used for distributing alert messages to a large population in a certain area in a quick way. For example, if a sensor unit is detecting that an earth quake is about to occur in a certain region, an information message may be generated and distributed to the users of a portable communication device in that region. If, e.g., a tsunami may be predicted, a message may be automatically generated and distributed to the users of a portable communication device 120 within the region. The message may be generated automatically by use of an adaptive template 110, exchanging the place holders 140 with relevant emergency information.

The terminology used in the detailed description of the particular exemplary embodiments illustrated in the accompanying drawings is not intended to be limiting of the invention. In the drawings, like numbers refer to like elements.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

The word “information as used herein is to be understood as meaning not only typographical letters but may also comprise pictures, images, animations, graphics, multimedia, movies, etc., which may be used for presenting a message or a piece of information to a user.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

1. A portable communication device comprising:
a detection unit;
a control unit; and
a memory including a message template for generating a message for a recipient, where:
the detection unit is configured to detect a physical characteristic, and
the control unit is configured to insert information corresponding to the detected physical characteristic, detected by the detection unit, into a pre-specified position in the message template.

2. The portable communication device according to claim 1, where the detection unit includes a position detecting unit and said physical characteristic includes position data corresponding to a present geographical position of the portable communication device.

3. The portable communication device according to claim 2, where the control unit is configured to map position data detected by the detection unit onto a natural language denomination, which is said information, before being inserted into the pre specified position in the message template.

4. The portable communication device according to claim 3, where the position data corresponds to a plurality of natural language denominations of different precision, where each of the plurality of natural language denominations corresponds to a geographical area of different size.

5. The portable communication device according to claim 4, where the control unit is configured to select the natural language denomination corresponding to the position data based on a distance between a home location of the recipient and the position data.

6. The portable communication device according to claim 5, where the control unit is configured to order the communication unit to send a message.

7. The portable communication device according to claim 1, where the detection unit comprises one or more of a temperature sensor, a Bluetooth unit, an accelerometer, a light sensor, a sensor measuring the sound level of the environment, a barometer, a sensor device for determine the air pressure, a humidity sensor, a breath analyzer, a clock, a calendar, a pulse meter, or a blood pressure sensor.

8. The portable communication device according to claim 1, comprising a plurality of detection units and a plurality of pre-specified positions in the information template.

9. A method for generating a message in a portable communication device by using a message template comprising at least one pre-specified position, said method comprising:
detecting a physical characteristic, and
inserting relevant information corresponding to the detected physical characteristic into the pre-specified position in the message template.

10. The method for generating a message according to claim 9, where the detected physical characteristic comprises position data corresponding to a present geographical position of the portable communication device.

11. The method for generating a message according to claim 10, further comprising mapping the data corresponding to the present geographical position onto a natural language denomination, which is said information.

12. The method for generating a message according to claim 9, further comprising:
detecting that the portable communication device is set into a template mode,
activating a detection unit, and
preparing the detected physical characteristic for presentation.

13. The method for generating a message according to claim 11, further comprising selecting the natural language denomination corresponding to the position data based on a home location of the recipient.

14. The method for generating a message according to claim 13, where selecting the natural language denomination corresponding to detected position data further comprise:
selecting the natural language denomination corresponding to a geographical area where the present geographical position of the portable communication device corresponds to a geographical area which is separate from the determined home location of the recipient.

15. The method for generating a message according to claim 14, further comprising sending the generated message automatically.

16. The method for generating a message according to claim 9, where the detected physical characteristic includes one or more of temperature, name of other Bluetooth units within range, accelerometer data, light intensity data, sound level data, barometer data, air pressure, height over the sea level, air humidity data, the users alcohol content when exhaling, time, calendar data, pulse, or blood pressure.

17. The method for generating a message according to claim 9, where the detection unit is continuously activated and the portable communication device is set into a template mode when the information corresponding to the detected physical characteristic reaches or exceeds a certain predetermined threshold value.

18. The method for generating a message according to claim 9, where a plurality of detection units are activated and a plurality of relevant information are captured and inserted into a plurality of pre-specified positions in the message template.

19. The method for generating a message according to claim 9, where a plurality of messages are distributed to a plurality of recipients.

20. A computer-readable medium including instructions executable by at least one processor, the computer-readable medium comprising:
one or more instructions for generating a message in a portable communication device by using a message template comprising at least one pre-specified position;
one or more instructions for detecting a physical characteristic; and
one or more instructions for inserting relevant information corresponding to the detected physical entity into the pre-specified position in the template.
